(19) United States
(12) Patent Application Publication
(10) Pub. No.: US 2013/0096831 A1
(43) Pub. Date: Apr. 18, 2013

(54) AUTOMATIC, ADAPTIVE AND OPTIMIZED SENSOR SELECTION AND VIRTUALIZATION

(71) Applicants: Hoi Yeung Chan, Stamford, CT (US); Rajarshi Das, Armonk, NY (US); Jonathan Lenchner, North Salem, NY (US)

(72) Inventors: Hoi Yeung Chan, Stamford, CT (US); Rajarshi Das, Armonk, NY (US); Jonathan Lenchner, North Salem, NY (US)

(73) Assignee: International Business Machines Corporation, Armonk, NY (US)

(21) Appl. No.: 13/275,827

(22) Filed: Oct. 18, 2011

(51) Int. Cl. G06F 19/00

(52) U.S. Cl. 702/1

(57) ABSTRACT

A system, method and computer program product for managing sensors. One example of embodiment includes a data reader to receive sensor measurements from sensors. A user value collector receives user values from users representing a user's measurement of an abstract concept. A data store saves the sensor measurements and the user values in computer readable memory. The system further includes a virtual sensor generator. The virtual sensor generator determines a mapping function based on the stored sensor measurements and user values. Furthermore, given a new set of sensor measurements from the sensors, the virtual sensor generator employs the mapping function to generate a new virtual sensor value.

### BACKGROUND

The present invention is directed toward electronic monitoring, and more particularly to adaptive and optimized sensor selection and virtualization.

With the wide spread availability of information sharing, accessible via the internet, and the popularity and low cost of various types of sensors, the utilization of such information and available sensor data creates an important challenge: how do we extract information from the thousands of sensors and data sources and use this information effectively and efficiently?

Information reuse and sharing are important aspects of the next generation of applications. Efficient reuse and sharing of information, especially information coming from the underlying tapestry of sensors can reduce application development costs and accelerate innovation.

Traditional approaches for sensor selection and deployment are often based on ad hoc decisions that do not take into consideration the known (or attempt to discover unknown) dynamics and interaction existing among system components and sensors, and the preferences and utilities of the information users. This can result in costly over-instrumentation and less than optimal use of the available sensors.

### SUMMARY

One example of the invention is a system for managing sensors. The system includes a data reader to receive sensor measurements from sensors. In addition, a user value collector receives user values from users representing a user's measurement of an abstract concept. A data store saves the sensor measurements and the user values in computer readable memory. The system further includes a virtual sensor generator. The virtual sensor generator determines a mapping function based on the stored sensor measurements and user values. Furthermore, given a new set of sensor measurements from the sensors, the virtual sensor generator employs the mapping function to generate a new virtual sensor value.

Another example of the invention is a method for managing sensors. The method includes a receiving step for receiving sensor measurements from sensors. Another receiving step receives user values from users representing a user's measurement of an abstract concept. The sensor measurements and the user values are stored in a storing step. A determining step determines a mapping function based on the stored sensor measurements and user values. A generating step generates a new virtual sensor value using the mapping function and the new sensor measurements from the sensors.

Yet a further example of the invention is a computer program product for managing sensors. The computer program product includes computer readable program code configured to receive sensor measurements from sensors, receive user values from users representing a user's measurement of an abstract concept, store the sensor measurements and the user values, determine a mapping function based on the stored sensor measurements and user values, and generate a virtual sensor using the mapping function and the sensor measurements from the sensors.

### BRIEF DESCRIPTION OF THE DRAWINGS

FIG. 1 shows an example embodiment of a system for managing sensors contemplated by one embodiment of the present invention.

FIG. 2 shows an example flowchart for a method of managing sensors.

FIG. 3 shows an example of a multilevel sensor configuration contemplated by the present invention for a datacenter.

FIG. 4 another example system using an Intelligent Sensor Selection Service contemplated by the present invention.

FIG. 5 shows an example system for managing sensors in accordance with the present invention.

### DETAILED DESCRIPTION

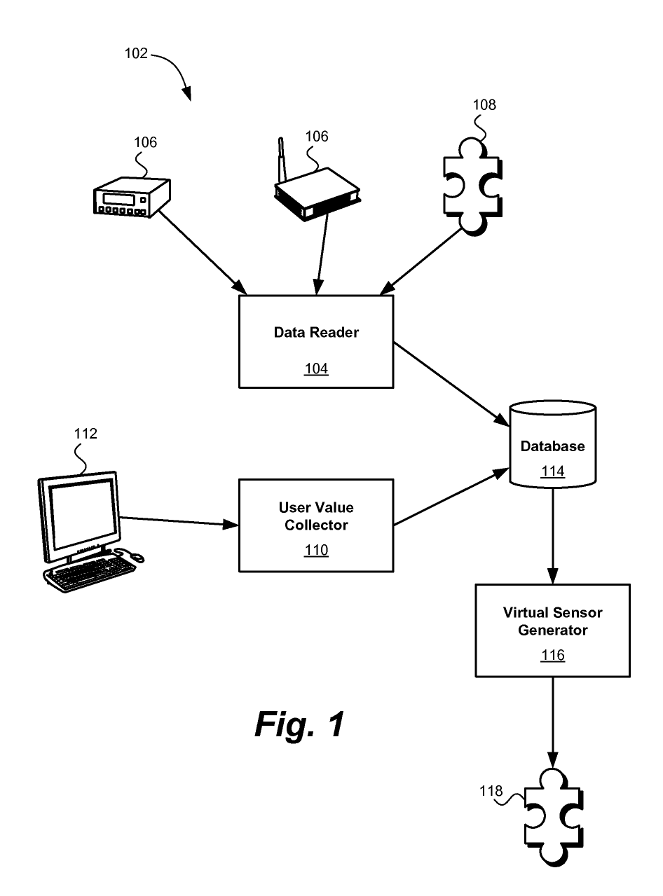

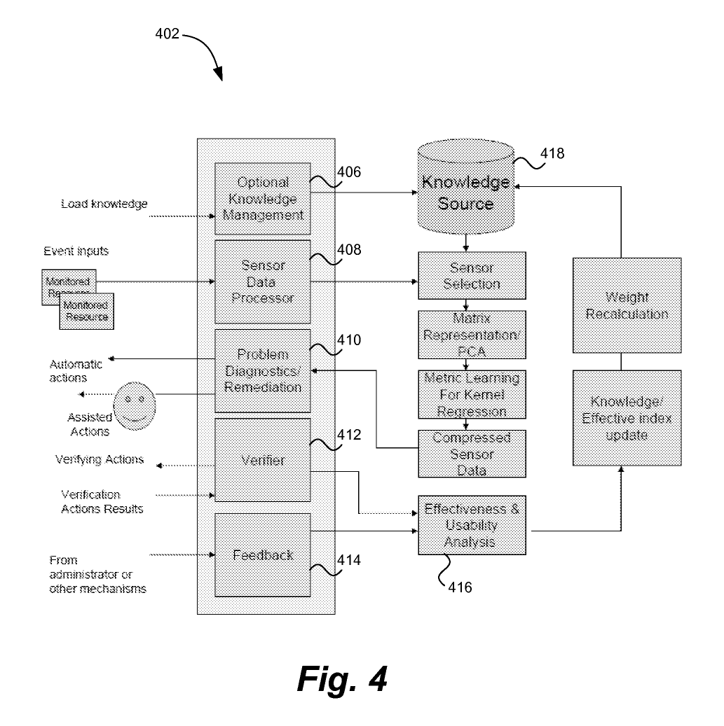

The present invention is described with reference to embodiments of the invention. Throughout the description of the invention reference is made to FIGS. 1-5. When referring to the figures, like structures and elements shown throughout are indicated with like reference numerals.

Embodiments of the present invention enable intelligent selection of a minimum set of sensors, estimation of sensor data for locations not directly covered by physical sensors, adaptation of the sensor selection to constantly changing environment conditions, and/or provide the knowledge required to perform expert level remediation. Furthermore, embodiments of the present invention may enable (1) intelligent selection of a minimum set of sensors and estimation of sensor values not directly available from physical sensors or available data, using regression, (2) construction of higher level virtual sensors from a collection of physical and virtual sensors driven by user utilities and preferences, and (3) updating of sensor repositories with newly constructed virtual sensors for reuse. FIG. 1 shows an example embodiment of a system 102 for managing sensors contemplated by one embodiment of the present invention.

The system 102 includes a data reader 104 to receive sensor measurements from sensors. The data reader 104 may receive sensor measurements from physical sensors 106 and/or virtual sensors 108. Examples of physical sensors 106 include light, sound, temperature and humidity sensors. Virtual sensors 108 are discussed in more detail below.

A user value collector 110 is configured to collect user values from users 112. The user values represent a user's measurement of an abstract concept. As used herein, an abstract concept is defined as a quantifiable objective not directly measurable by a physical sensor. An example of an abstract concept is physical comfort and its associated user value is a user's physical comfort level on a scale of 1 to 10 (or some other scale).

The system 102 includes a database 114 or other data store coupled to the data reader 104 and user value collector 110. The database 114 stores both the sensor measurements received by the data reader 104 and the user values received by the user value collector 110. For example, the database 114 may include a table of sensor values. The table includes rows with the sensor's identity, the sensor reading, and the time the reading was taken. Similarly, a table of user values may include rows with the user's identity, the user value, and the time the user value was received.

A virtual sensor generator 116 is coupled to the database 114. The virtual sensor generator 116 generates a virtual sensor 118 that simulates a physical sensor for the purpose of sensing the abstract concept (e.g., a physical comfort sensor). For example, the virtual sensor generator 116 determines a mapping function f(X) where X is a subset of physical and other virtual sensors that linearly or non-linearly combines this subset of sensors to generate virtual sensor readings based on the stored sensor measurements and user values in the database 114. The mapping function f(X) mathematically describes the abstract concept to be measured based on the sensors. The virtual sensor generator 116 then generates the virtual sensor 118 using the function f(X) and the sensor measurements from the sensors 106 and 108.

In one embodiment, the virtual sensor 118 is generated by assigning weights to the sensors and taking the weighted sum of the sensor values. For example, if temperature has more effect on physical comfort than light and humidity, the temperature sensor may be assigned greater weight than the light and humidity sensors. In a particular embodiment, the virtual sensor generator 116 is configured to use a distance metric to generate the virtual sensor 118.

The virtual sensor generator 116 may be configured to translate the sensor measurements to a multidimensional space. For example, the space of possible readings for each of the sensors can represent one dimension in the multidimensional space. Once translated, the sensor generator 116 selects a mapping function f(X) that linearly or non-linearly combines a subset of sensors to generate virtual sensor readings, which taken together are the most effective at predicting the measured (or potentially measured) value of the abstract concept. The virtual sensor generator 116 then assigns computational weights to the sensors, and if the combination of sensors is non-linear, it also stores a description of the functional form of the combination.

The virtual sensor generator 116 may be configured to automatically update the mapping function when new information is stored in the database 114. It is contemplated that the new information includes a new measurement from the sensors 106 and 108 and/or a new user value for the abstract concept.

The system 102 may use Principal Component Analysis (PCA) to construct a sensor matrix as input for linear dimensionality reduction from which a set of principal sensors are extracted. The system may extrapolate sensor data onto uncovered (unmonitored) regions by utilizing nearby sensor data. The degree of sensor coverage can depend on user requirements. The system 102 may also select the best group of physical and virtual sensors (in the sense of minimizing the predictive error of the group, given some constraint, e.g., on the number, or total cost, of sensors to be employed) to create higher level sensors. For example, physical/virtual sensor inputs may be represented as a matrix with each sensor determining a column, as input for dimensionality reduction. A metric is created which determines when two test points are close to one another along dimensions which are relevant for measuring the abstract concept. A set of principal sensors are extracted using the metric. The system 102 applies regression techniques and projects sensor data onto unmonitored regions by extrapolating from the values of nearby sensors, where the notion of “nearby” is determined by the previously computed metric. Virtual sensors are constructed and the system 102 updates the available sensor repository with newly constructed virtual sensors.

Consider, as an example, a large building B with R rooms of different types in terms of size and function. Each room has many different types of active physical sensors to frequently report on various physical attributes (e.g., temperature, humidity, sound-level, light intensity, wireless signal strength) at specific locations within that room. Each room is also associated with other quantifiable physical attributes that are fixed or change less frequently, such as the room's size, volume, floor number in the building) distance to nearest rest-room, distance to nearest elevators, number of power outlets, number of available chairs, number of computer-display units, number of microphones, etc. We will represent the ordered list of the reported values of all such N physical attributes (some of which are binary, some categorical, and some numerical) in room r at time t as a vector X^{r} (t)=[x^{r}₁(t), . . . , x^{r}ᵢ(t), . . . , x^{r}_{N} (t)] where r is in the set {1, . . . , R} and i is in the set {1, . . . , N}. Note that the set of N reported values, x^{r}ᵢ(t), could be classified based on the type of the underlying physical attribute (e.g., all 5 sensors values, x^{r}ᵢ(t), . . . , x^{r}ᵢ₊₄(t), report temperatures measured at 5 different locations inside the room r). Additionally, the vector X^{r} (t) itself could be classified based on t, the time of the day, week, month, season, etc, in which it was collected. Without loss of generality, we will drop the time index t in the subsequent discussion.

Case 1: Virtual Sensor individualized for a single person.

The rooms in building B are visited by a person p in no particular order. Upon visiting a room r, the person p reports his/her relative level of comfort c in that room on a scale from 0 through 100 (i.e., c=0 is worst, and c=100 is best). c is regarded as a virtual sensor representing the combined, weighted values of its associated physical sensors. When p has visited a large number of rooms, then we can represent all the reported values of c in a vector C=[c₁, . . . , c_{R}]. From the sensor values X and the reported values of c, we will learn a matrix A where:

AX=C

X is an N×R matrix of sensors and the corresponding sensor values

TABLE 1
An example N × R matrix for sensors and sensor values

| | Room1 | Room2 | Room3 | . . . | RoomR |
|---|---|---|---|---|---|
| Value (sensor1) | V11 | V12 | V13 | . . . | V1R |
| Value (sensor2) | V21 | V22 | V23 | . . . | V2R |
| Value (sensor3) | V31 | V32 | V33 | . . . | V3R |
| . . . | . . . | . . . | . . . | . . . | |
| Value (sensorN) | VN1 | VN2 | VN3 | . . . | VNR |

C is a single row table (1×R matrix) of c values:

| | | | | |
|---|---|---|---|---|
| Room1 | Room2 | Room3 | . . . | RoomR |

| | | | | |
|---|---|---|---|---|
| Value | c1 | C2 | C3 | cR |

A is the learned transformation matrix with size 1×N to project the aggregate sensor values into a virtual sensor c:

| | | | | |
|---|---|---|---|---|
| Sensor1 | Sensor2 | Sensor3 | . . . | SensorN |

| | | | | |
|---|---|---|---|---|
| Value | A1 | A2 | A3 | AN |

Using recorded X and C to find A.

Using Nearest Neighbor Classification techniques, the quality of predictions automatically increases with more data. We will use the simplest possible metrics, the quadratic (Mahalanobis) distance measures:

dᵢⱼ=(xᵢ−xⱼ)^{T}Q(xᵢ−xⱼ)=xᵢⱼ^{T}Qxᵢⱼ

xᵢ is the input vector for the ith recorded case and Q is a symmetric, positive semi-definite matrix.

Rewriting this using eigendecomposition of Q:

$$\begin{matrix}{d}_{ij} = {( {x}_{i} - {x}_{j} )}^{⊤} {A}^{⊤} A ( {x}_{i} - {x}_{j} ) \\ = {( {Ax}_{i} - {Ax}_{j} )}^{⊤} ( {Ax}_{i} - {Ax}_{j} ) \\ = {( {y}_{i} - {y}_{j} )}^{⊤} ( {y}_{i} - {y}_{j} )\end{matrix}$$

which is equivalent to applying Euclidean metric to the points:

yᵢ=Axᵢ

If p visits a new room with sensor values Xj, and from AX=C, we can predict the virtual sensor value cⱼ. (We can also exclude less-important sensors from X via PCA.) If p has accepted the automatic settings of these attributes, the sensor data set will be recorded to add to the learning database with a corresponding value of c=100. If p needs to adjust the values of the physical attributes in the room to meet his comfort level, the newly adjusted values and the new reported c value will be recorded.

Case 2: Demographic information (e.g., age, gender, type of profession, etc.).

To include demographic parameters of each p into the input sensor values, which is equivalent to scaling the sensor values by the relative weights of each of the demographic parameters, we can simply project the demographic matrix to include the effect of demographic influence, with one matrix of value per person reporting. Thus, for Person p:

| (Person p) | Room1 | Room2 | Room3 | . . . | RoomR |
|---|---|---|---|---|---|
| Age | V11 | V12 | V13 | . . . | V1R |
| Gender | V21 | V22 | V23 | . . . | V2R |
| Profession Type | V31 | V32 | V33 | . . . | V3R |
| . . . | . . . | . . . | . . . | . . . | |
| AttributeM | VM1 | VM2 | VM3 | . . . | VMR |

X′=[XD]

Case 3: More than one person.

Apply case 1 to each p, average X to represent the combined values for all p.

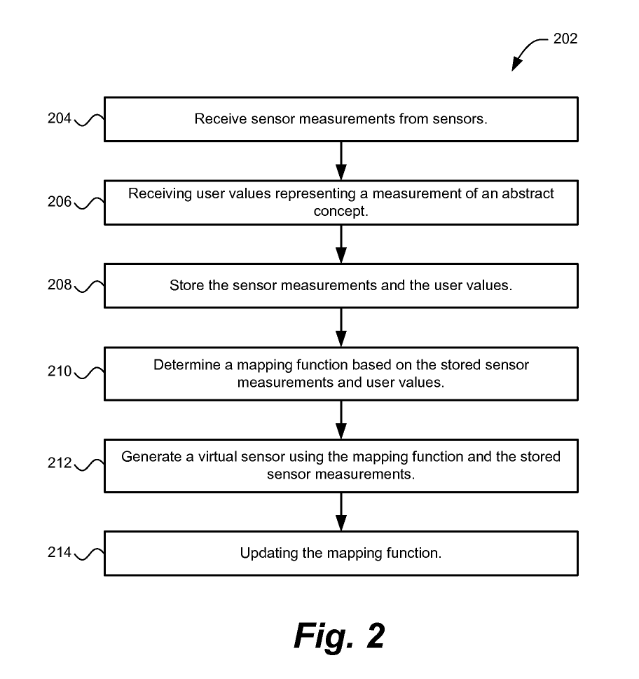

With reference now to FIG. 2, an example flowchart for a method of managing sensors is shown. The method includes a receiving step 202. During this operation, sensor measurements are received from sensors. As mentioned above, the sensor measurements may be received from physical sensors and/or previously generated virtual sensors.

The method also includes receiving step 204. During this step, user values are received from users. The user values represent a user's measurement of an abstract concept, such as the user's physical comfort level. After receiving step 204 is completed, control passes to storing operation 206.

At storing operation 208, the sensor measurements and the user values are stored in a database or other data store. After storing operation 208 is completed, control passes to determining operation 210.

At determining operation 210, a mapping function is determined based on the stored sensor measurements and user values. More particularly, the operation determines a mapping function f(X) where X is a subset of physical and/or virtual sensors and f( ) linearly or non-linearly combines this subset of sensors to generate virtual sensor readings which best predicts the average user value for the measured concept. This operation may include translating the sensor measurements to a multidimensional space such that each of the sensors represents one dimension in the multidimensional space, selecting the sensors providing nearest points in the multidimensional space relative to the mapping function, and assigning computational weights to the sensors. Once determining operation 210 is completed, process flow continues to generating operation 212.

At generating operation 212, a virtual sensor is generated using the mapping function and the sensor measurements from the sensors. More particularly, the operation generates a virtual sensor using the mapping f(X) plus the sensor measurements from the subset of sensors X. As discussed above, generating the virtual sensor may include assigning a computational weight to each of the sensors. Furthermore, generating a virtual sensor may include using a distance metric.

Next, at updating operation 214, the mapping function is automatically updated when new information is stored in the database. That is, the mapping function f(X) is updated based on new user values for the abstract concept. New information may include a new sensor measurement from the sensors and/or a new user value.

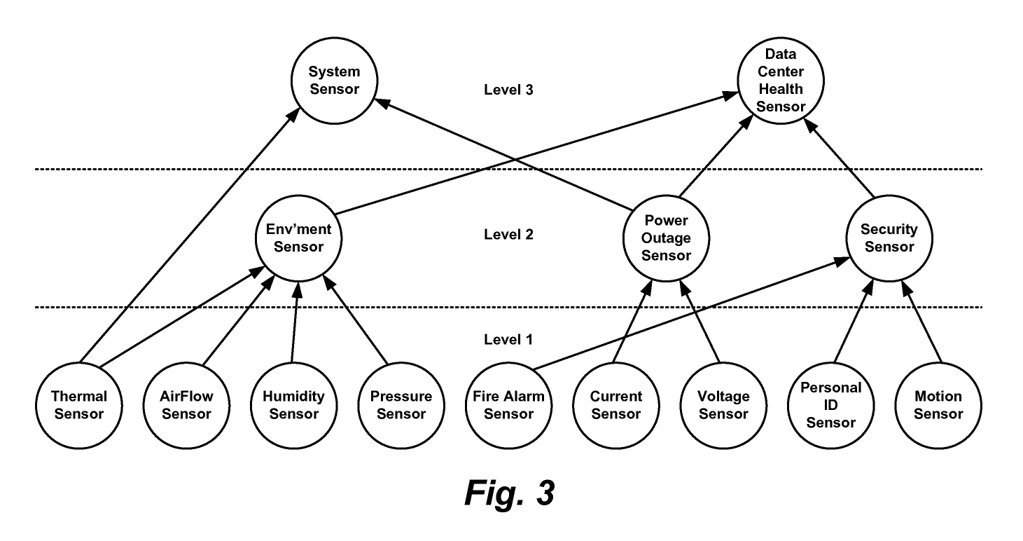

FIG. 3 shows an example of a multilevel sensor configuration contemplated by the present invention for a data center. In this embodiment, the sensors at Level 1 are physical sensors. That is, they report measurements of physical conditions. The sensors at Level 2 are virtual sensors generated from weighted measurements of physical sensors from Level 1. Finally, the sensors at Level 3 are virtual sensors generated from weighted measurements of virtual sensors from Level 3.

Thus, in an embodiment of the invention using a PCA technique to construct a sensor matrix as input for linear dimensionality reduction, a meaningful distance metric is created from which a set of principal sensors are extracted. These sensor values may be extrapolated to cover the required monitoring region, using the distance metric. Extraction of the most relevant set of physical and virtual sensors from an arbitrarily large set of physical and virtual sensors is performed automatically.

Traditional approaches for sensor selection and deployment are often based on ad hoc decisions that do not take into consideration the known dynamics and interactions existing among system components and sensors, and the preferences and utilities of the information user. This usually results in costly over-instrumentation and less than optimal use of the available sensors.

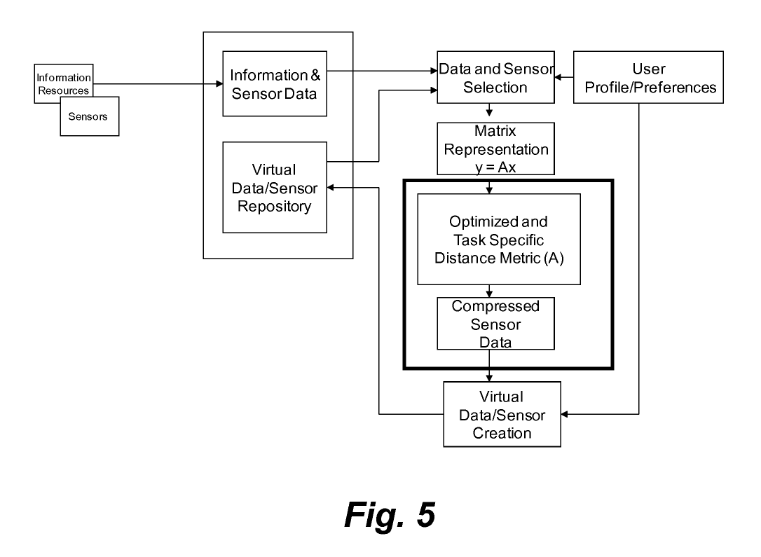

FIG. 5 shows another example system for managing sensors in accordance with the present invention. As shown, a data and sensor selection unit receives user preferences. The preferences may be included in a user profile. The data and sensor selection unit also receives information from sensors and a virtual data/sensor repository. The data and sensor selection unit can represent physical/virtual sensor inputs as a matrix with each sensor as a row sensor matrix as input for dimensionality reduction.

A metric is created which determines when two test points are close to one another along dimensions which are relevant for measuring the abstract concept. A set of principal sensors are then extracted using the metric. The system then applies regression techniques and projects sensor data onto unmonitored regions by extrapolating from the values of nearby sensors, where the notion of “nearby” is determined by the previously computed metric. The system then applies regression techniques and projects sensor data onto unmonitored regions by extrapolating from the values of nearby sensors, where the notion of “nearby” is determined by the previously computed metric. The system can then update the available sensor repository with newly constructed virtual sensors. The approaches contemplated require no formal a priori model of the underlying physical processes, are scalable to large numbers of sensors, automatically group most relevant sensors rather than requiring that they be grouped manually, use well-defined mathematical and matrix techniques and tools which are readily available, and/or are extensible to a variety of sensor applications.

In view of the forgoing, embodiments of the invention can address these issues by:
enabling intelligent selection of a minimum set of sensors and information;
estimating sensor values not directly available from physical sensors or available data by regression (i.e., creating and deploying virtual sensors);
constructing higher level virtual sensors from a collection of physical and virtual sensors driven by user utilities and preferences; and
updating a sensor repository with newly constructed virtual sensors.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preferred embodiments to the invention have been described, it will be understood that those skilled in the art, both now and in the future, may make various improvements and enhancements that fall within the scope of the claims which follow. These claims should be construed to maintain the proper protection for the invention first described.

What is claimed is:

1. A system for managing sensors, the system comprising:
a data reader to receive sensor measurements from physical sensors;
a user value collector to receive user values from users representing a user's measurement of an abstract concept; and
a data store to store the sensor measurements and the user values; and
a virtual sensor generator to:
determine a mapping function based on the stored sensor measurements and user values; and
generate a virtual sensor using the mapping function and the sensor measurements from the sensors.

2. The system of claim 1, wherein the sensor measurements received by the data reader includes measurements from at least one of a physical sensor and a previously generated virtual sensor.

3. The system of claim 1, wherein the virtual sensor is generated by assigning computational weights to a least one of physical component sensors and virtual component sensors derived by optimizing the ability of the physical and virtual component sensors to predict the value of the virtual sensor.

4. The system of claim 1, wherein the virtual sensor generator is further configured to automatically update the mapping function when new information is stored in the data store, the new information including at least one of a new measurement from the sensors and a new user value.

5. The system of claim 1, wherein the virtual sensor generator is further configured to use a distance metric to generate the virtual sensor.

6. The system of claim 5, wherein the distance metric is based on a user's assignment of values to the abstract concept measured by the virtual sensor and is automatically adjusted to derive maximum predictive power for the user or group of users assignment of value to the abstract concept over time.

7. The system of claim 1, wherein the virtual sensor generator is further configured to:
transform the sensor measurements within a multidimensional space;
select the sensors providing nearest points in the multidimensional space relative to the mapping function; and
assign computational weights to the sensors.

8. The system of claim 7, wherein, for each sensor, the set of possible sensor readings represents a separate dimension in the multidimensional space.

9. A method for managing sensors, the method comprising:
receiving sensor measurements from sensors; and
receiving user values from users representing a user's measurement of an abstract concept; and
storing the sensor measurements and the user values; and
determining a mapping function based on the stored sensor measurements and user values; and
generating a virtual sensor using the mapping function and the stored sensor measurements from the sensors.

10. The method of claim 9, wherein receiving sensor measurements from the sensors includes receiving the sensor measurements from at least one of a physical sensor and a previously generated virtual sensor.

11. The method of claim 9, wherein generating the virtual sensor includes assigning a computational weight to each of the sensors.

12. The method of claim 9, further comprising automatically updating the mapping function when new information is stored in a database, the new information including at least one of a new sensor measurement from the sensors and a new user value.

13. The method of claim 9, wherein generating the virtual sensor includes using a distance metric.

14. The system of claim 13, wherein the distance metric is based on a user's assignment of value to the abstract concept to be predicted by the virtual sensor and is automatically adjusted to drive maximum predictive capability for the user or group of users over time.

15. The method of claim 14, further comprising:
transforming the sensor measurements within a multidimensional space;
selecting the sensors providing nearest points in the multidimensional space relative to the mapping function; and
assigning computational weights to the sensors.

16. The method of claim 15, wherein, for each sensor, the set of possible sensor readings represents a separate dimension in the multidimensional space.

17. A computer program product for managing sensors comprising:
a computer readable storage medium having computer readable program code embodied therewith, the computer readable program code configured to:
receive sensor measurements from sensors; and
receive user values from users representing a user's measurement of an abstract concept; and
store the sensor measurements and the user values; and
determine a mapping function based on the stored sensor measurements and user values; and
generate a virtual sensor using the mapping function and the sensor measurements from the sensors.

18. The computer program product of claim 17, wherein the computer readable program code for receiving the sensor measurements includes computer readable program code for receiving the sensor measurements from at least one of a physical sensor and a previously generated virtual sensor.

19. The computer program product of claim 17, wherein the computer readable program code for generating the virtual sensor includes the computer readable program code for assigning a computational weight to each of the sensors.

20. The computer program product of claim 17, further comprising computer readable program code for automatically updating the mapping function when new information is stored in a data store, the new information including at least one of a new sensor measurement from sensors and a new user value.

21. The computer program product of claim 17, wherein the computer readable program code for generating the virtual sensor includes the computer readable program code for using a distance metric.

22. The computer program product of claim 21, wherein the distance metric is based on a user's utility and is automatically adjusted to drive maximum utility for the users over time.

23. The computer program product of claim 17, wherein the computer readable program code for generating the virtual sensor includes the computer readable program code for:
transforming the sensor measurements within a multidimensional space;
selecting the sensors providing nearest points in the multidimensional space relative to the mapping function; and
assigning computational weights to the sensors.
